(19) United States
(12) Patent Application Publication
(10) Pub. No.: US 2011/0030646 A1
(43) Pub. Date: Feb. 10, 2011

(54) JET EXHAUST PISTON ENGINE

(76) Inventor: Leonard D. Barry, Detroit, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/853,358

(22) Filed: Aug. 10, 2010

Related U.S. Application Data
(60) Provisional application No. 61/232,664, filed on Aug. 10, 2009.

(51) Int. Cl. F02F 3/00

(52) U.S. Cl. 123/193.6

(57) ABSTRACT

This invention is a piston in cylinder engine using water injection into a relative vacuum heated to steam by expanding in the cylinder and by an electric arc or other heat source. The resulting steam explosion applies a work force on the piston. The piston has jet nozzles uncovered at the end of its work stroke to jet the piston to help propel it during the return stroke and to form a vacuum in place of the usual compression stroke. The piston has a cover plate with tapered pins depending into jet nozzles through the piston to block the jet nozzles during the main work stroke.

### RELATED APPLICATIONS

This application claims priority of U.S. Provisional Patent application Ser. No. 61/232,664 filed Aug. 10, 2009 which is incorporated herein by reference.

This invention is a reciprocating piston two-stroke engine

### FIELD AND BACKGROUND OF THE INVENTION

Unlike present engines it uses exhaust gas to propel during the return stroke of the piston. It is especially designed to make steam at a low pressure or vacuum in the head end of a cylinder from hot water or steam injection. Preferably an electric arc adds heat in the cylinder to keep steam under increased pressure for the work stroke. It has jet nozzles in the piston opened at the end of the work stroke to help propel the exhaust stroke and exhaust the cylinder during the return stroke to a low pressure before the next cycle where it would first draw a vacuum and take on a small charge of water that turns to steam.

Internal combustion engines now compress an sir fuel mix which is ignited in the cylinder to push the piston. Water injection is known to increase efficiency but damages the cylinder mainly because of sulfur in the fuel making sulfuric acid in the cylinder. My engine can eliminate fuel in the cylinder so water can be used to make steam in the cylinder with minimum damage to the engine by using an electric arc or heat in place of fuel.

It takes a low pressure to make steam at a low temperature but if heat is added faster than the pressure rise that would turn it back to water it can make a cool engine because the heat is taken up in making steam. This saves the need for a cooling jacket or fins, thus reducing weight and loss of heat which the present internal combustion engines have for needed cooling.

### SUMMARY OF THE INVENTION

It is an object to reduce or eliminate return stroke pressure, to eliminate the compression stroke, and to drive the piston return stroke with exhaust jets.

An object is to draw a vacuum in the head end of the cylinder to turn water into steam at low pressure at the same time an electric arc is introduced to heat the water and vapor to make and keep steam as the pressure goes up when the piston works under this pressure.

It is an object to provide a pressure relief valve in the cylinder to prevent too high a pressure.

It is an object to utilize the explosive force when the water turns to steam. It is an object to provide a low temperature engine to reduce heat loss by providing heat to change water to steam at the point and time of use.

It is an object to eliminate burning gases in the cylinder, the need to exhaust them, and the compression stroke.

It is an object to eliminate the steam boiler and the heat loss from steam made in the boiler before it is used.

It is an object to use water injection to strike an electric arc in the cylinder to explode the water into steam.

It is an object to explode water into steam in the cylinder to best utilize heat before lost.

It is an object to an engine operable with different sources of heat.

It is an object to operate a closed cycle using the same water over and over, and not need a fuel tank—only a battery.

It is an object to reduce the weight and heat loss of the steam engine by putting a boiler in the cylinder.

It is an object to combine a reciprocating piston and jet in one engine. It is an object to obtain work from the exhaust stroke.

### BRIEF DESCRIPTION OF THE DRAWINGS

These other and further objects should be evident to those skilled in the art by study of this specification with reference to the accompanying drawings wherein:

FIG. 1 is a side view of an engine with cylinder and piston shown in section, rotation clockwise at 9 o'clock, and exhausting.

FIG. 2 is a plan section taken on line 2-2 of FIG. 1.

FIG. 3 is a side-view of the lower half of FIG. 1.

FIG. 4 is a perspective view of a piston rod,

FIG. 5 is a face view of an injection cam.

FIG. 6 is a bottom view of the cam shaft in FIG. 3.

FIGS. 7, 8, and 9 are respectively top, side, and bottom views of a piston cover.

FIGS. 10, 11, and 12 are respectively top, side and bottom views of a jet piston.

FIG. 13 is a sectional view of a portion of the jet piston engaging its cover piston showing a jet plug engaged by a jet nozzle to larger scale.

FIGS. 14, 15, and 16 are reduced front views of the engine cylinder and crank taken at 12 o'clock, 3 o'clock, and 6'clock respectively.

FIG. 17 is a side sectional view of the cylinder cap with input connections to larger scale.

FIG. 18 is a schematic of the engine controls.

FIGS. 19 and 20 are front and side views of a variation of the piston cover lift mechanism.

FIG. 21 is a side enlargement of a piston lift cam of FIGS. 19 and 20 on a portion of the crankshaft.

FIGS. 22 and 23 are front and side sections of a preferred variation of a piston for the engine.

FIG. 24 is a bottom view of the preferred lid for the piston.

FIG. 25 is a vertical section of the top portion of the cylinder with a glass cap receiving concentrated sun light for turning water into steam in the cylinder.

FIG. 26 is a schematic of the heat engine.

FIG. 27 is a vertical section of the cylinder with a jet exhaust deflector deflecting the exhaust against the bottom of the piston during the return stroke.

### DETAILED DESCRIPTION OF THE INVENTION

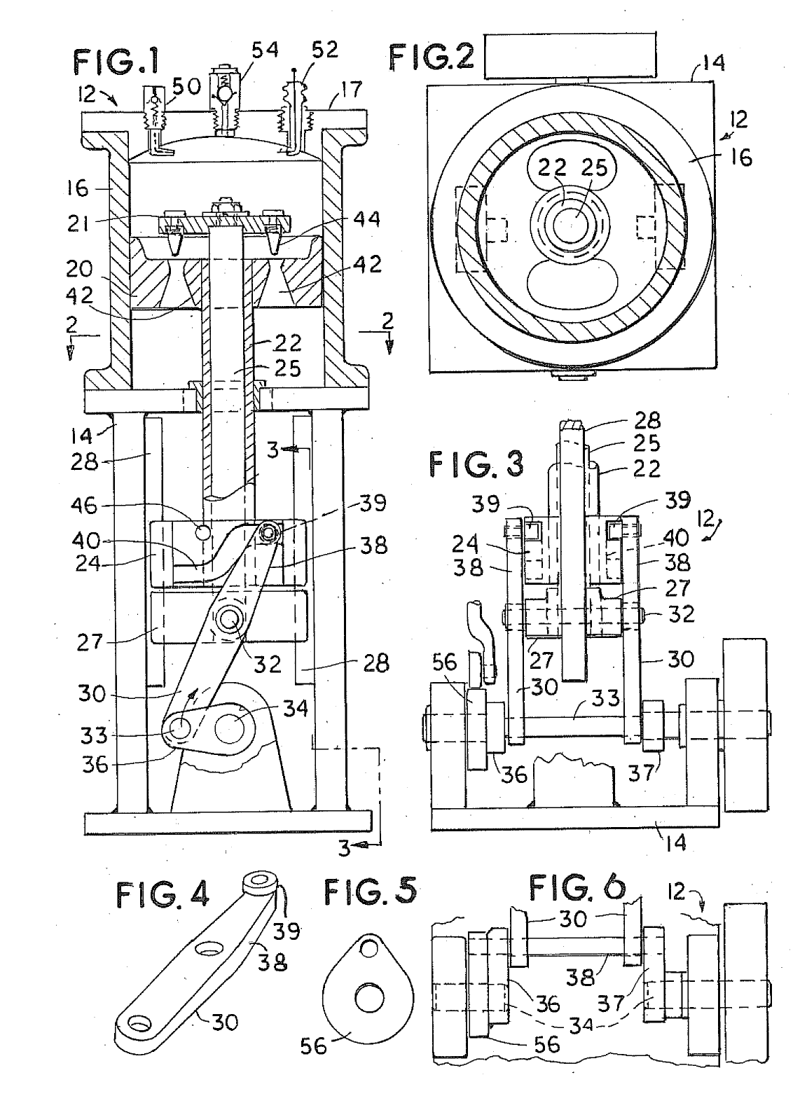

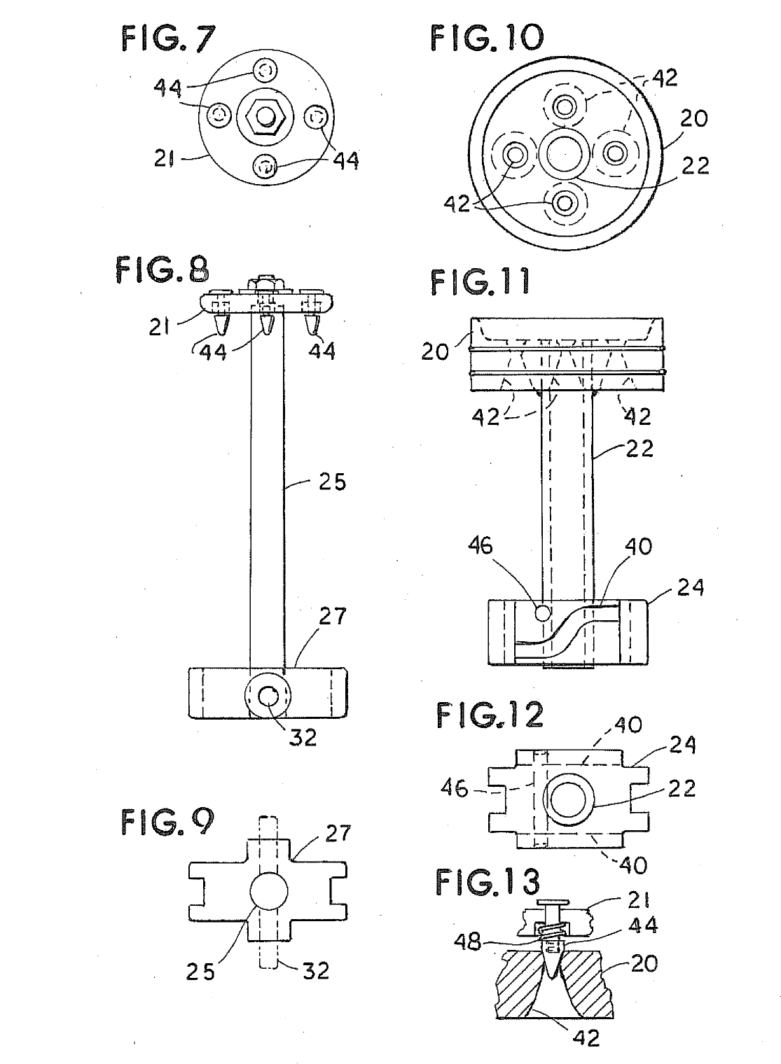

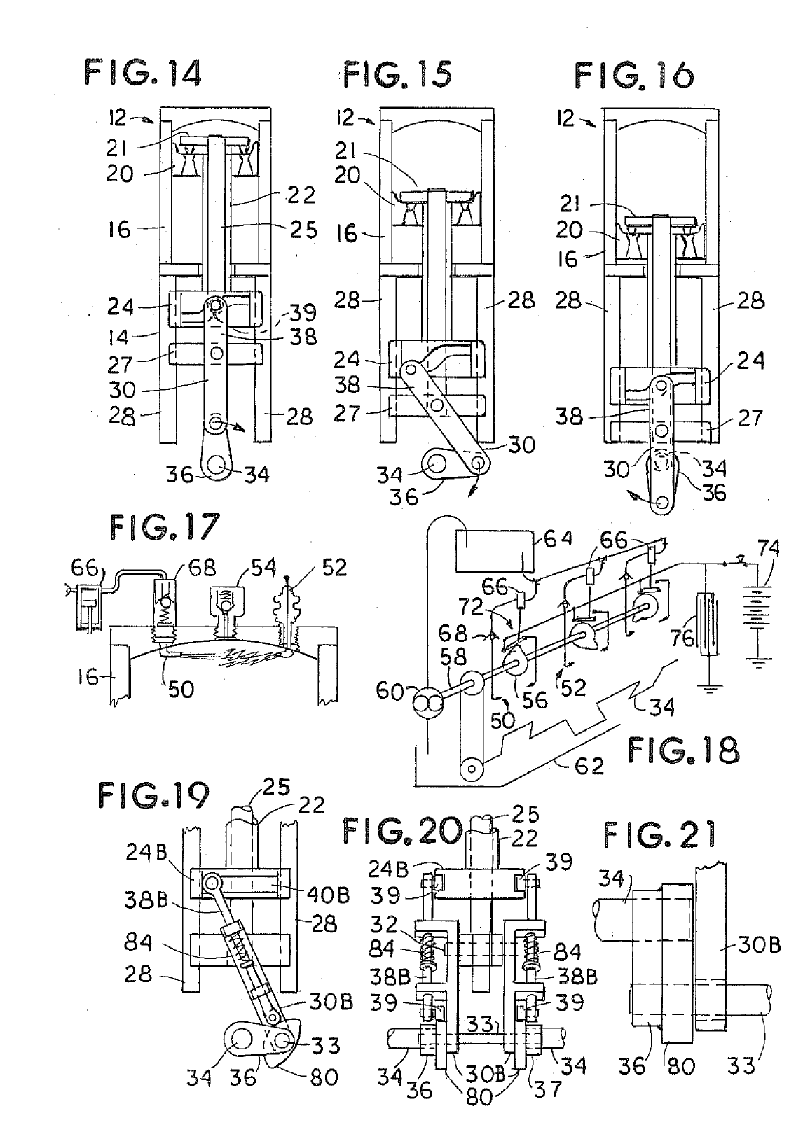

Referring to the drawings and in particular to FIGS. 1-18, engine 12 has a block or frame 14 with one or more cylinders 16. Each cylinder 16 has cap 17 a jet piston 20, and a piston lid 21 fitting over the jet piston. The jet piston is secured on a central tube 22 extending down to a crosshead 24. Piston lid 21 has a central rod 25 extending slip fit through tube 22 to a crosshead 27. Crossheads 24 and 27 have end slots to slide along guides 2P to hold the jet piston and 1d in alignment. Crosshead 27 can be omitted since rod 25 can be extended to hold pin 32.

A twin connecting rod 30 is connected on pin 32 to crosshead 27 and connected on pin 33 to crankshaft 34 between crank arms 36 and 37. Connecting rod 30 has twin cam arms 38 each extending up past crosshead 27 and along front and back faces of crosshead 24 each holding a cam roller 39 in a recessed cam track 40 on opposite faces of crosshead 24. Arms 38 swing cam rollers 39 from side to side along cam track 40 as they pass dead centers. Cam tracks 40 take a steep down slope to the left at center, FIG. 1, to lift the jet piston to close onto the lid for the power down stroke and lower the piston to open the lid for the exhaust powered up stroke.

Jet piston 20 has jet nozzles 42 through it and reciprocates under piston lid 21 to raise and lower to cover the nozzles during the down power stroke and uncover the nozzles during the exhaust up stroke. Piston lid 21 is a disk or open pattern with depending conical plugs 44 that align and fit into nozzles 42 when the jet piston is raised against the piston lid during the pressure work stroke until the connecting rod rollers 39 lower the jet piston relative to the piston lid to exhaust the cylinder on the up stroke. Tube 22 is tight fit or threaded in crosshead 24 and secured by pin 46 for assembly.

Referring to FIG. 13, each nozzle plug 44 is mounted in a hole in lid 21 and extended out by spring 48 to recess when engaged in a jet nozzle in jet piston 20 to help insure that each plug 44 seats securely when the jet piston is pushed against the lid.

Referring to FIGS. 1, 17 and 18, cylinder cap 17 has three tapped holes for various fittings; a water or steam or fuel injector nozzle 50, a spark or electric arc plug 52, and a safety valve 54. Nozzle 50 is directed at plug 52 to strike an arc or combustion. A cam 56 on crankshaft 34 or on cam shaft 58, FIG. 18, if the engine has more than one cylinder, controls the charge and ignition in the cylinders. A cam 56 on crankshaft 34 controls the water, steam, and or fuel injection and the arc or ignition for each cylinder.

Referring to FIGS. 17 and 18 for a water and steam injection steam engine, water pump 60 is driven from crankshaft 34 and piped to return condensate from condenser 62 to tank or boiler 64 which is piped through an injector pump 66 and back flow check valve 68 to each plug nozzle 50. Each injector 66 is a cylinder with piston operated by a cam 56 to meter and force a small amount of water (or steam) into the cylinder 17 controlled by that cam 56.

A cam 56, FIG. 5, for each cylinder 16 is secured on shaft 34 or on cam shaft 70 driven off crank shaft 34. Cam 56 closes contacts in a circuit from the negative of battery 74 to the pointed conductor on insulated plug 52 which sends an arc to plug 50 when started by a stream of conducting water aimed from plug 50 to the pointed end on plug 52. Plug 50 is grounded to the positive of battery 74. Electric condenser 76 across battery 74 reinforces the arc.

### Operation

This engine has a large range of possible operation from high pressure steam injection to water injection into a vacuum dropping in pressure as the piston pulls a vacuum at the start of the down stroke until the water is exploded into steam. The ignition 52 is omitted for operation as a straight steam engine but can be an electric heating coil which is shorted out to form an arc just after water injection. The water injected would furnish a path to strike an arc to heat the water to steam during the down work stroke. The exhaust jets 42 from piston 20 furnish power (work) on the up exhaust stroke and eliminate work of compression.

### Variations

Similar parts are given the same reference numbers with suffix added where modified.

Referring to FIGS. 19-21 for a variation of the lower portion of the engine, a jet piston lift cam 80 is secured to each crank arm 36 and 37 on pin 33. A cam follower rod 38B is supported to slide parallel on each connecting rod 30B and has a cam roller 39 at each end, one to follow on can 30 and the other to travel in a straight cam track 40B on crosshead 24B. Cam 80 is turned with the crankshaft to lift and lower piston 20 relative to lid 21 as in FIG. 1. Springs 84 hold rods 82 on cams 80. Cam 80 is shaped and positioned to block and open jets 42 as described.

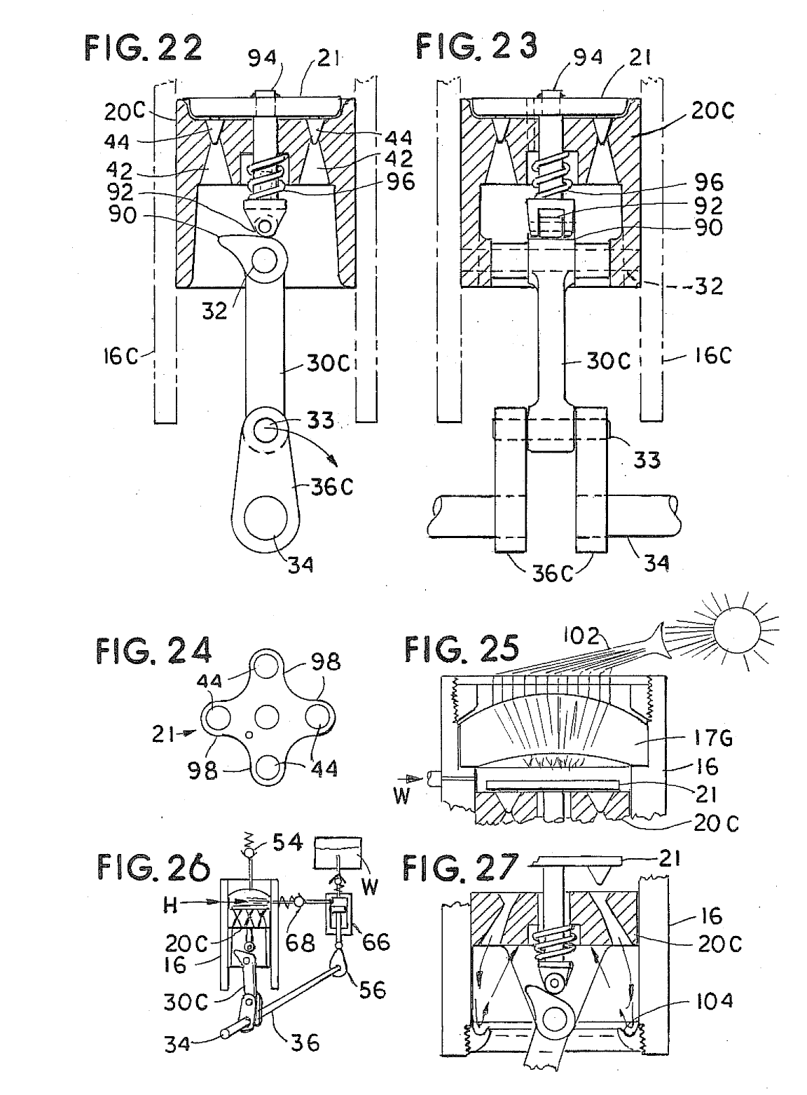

Referring to FIGS. 22 and 23 for a preferred variation of the engine, piston 20C has pin 32 supporting piston rod 30C in the usual arrangement for internal combustion engines. Rod 30C has a cam 90 on the upper end face inside the piston. Cam 90 is engaged by cam roller 92 on a cam rod 94 secured to lid 21 and mounted to slide up and down in a hole through piston 200 to open the lid for the exhaust stroke from about 5-12 o'clock and to close the lid for the power stroke from about 1-5 o'clock rotation of crank 36C. Roller 92 is held against cam 90 by coil spring 96 pocketed in piston 20C around rod 94. Piston 20C has jet nozzles 42 closed by lid 21 with stoppers 44 secured to the lid.

The preferred lid 21, FIG. 24, has arms 98 that hold stoppers 44 and present less restriction to flow than a solid lid.

Referring to FIG. 25, the head on cylinder 16 can be high temperature glass 17G to let concentrated sunlight directed in by optical fibers or tubes 102 to heat the head end of cylinder 16 for the full cycle to accumulate heat to make steam at the start of each cycle.

The schematic heat engine, FIG. 26, has cylinder 16 with piston 20C closed to pull a vacuum at the start of the down stroke to draw in a small metered amount of hot water under pressure through pressure check valve 68. The water is exploded to steam by internal and external heat to drive the piston down to where lid 21 opens jets 44 to exhaust the cylinder on the up stroke and next closes to pull a vacuum at the start of the next down stroke to take a charge of water for the next cycle. This engine can be made to operate on air, steam, or internal combustion fuel and the cylinder heated internally and/or externally with or without water injection.

Referring to FIG. 27, cylinder 16 can have a jet exhaust deflecting ring 104 in the bottom below the lowest extent of the rim of the piston to direct the exhaust jets up against the bottom of the piston. The jet nozzles 44 through the piston are directed toward the wall of the cylinder at a slight angle which further helps the return stroke.

Having thus described my invention with a few variations, these are not intended as a limit on the scope of my invention which is intended to be covered by the following claims in all variations which become apparent to those skilled in the arts and which come within the true spirit and scope of this my invention.

The invention claimed is:

1. A reciprocating piston engine having a power and an exhaust stroke, a least one cylinder with a piston with at least one opening through it front to back to exhaust the fluid in the head end during the exhaust stroke, and a lid for sealing said opening closed during the power stroke, and can means for opening said lid during the exhaust stroke and for closing the lid during the power stroke.

2. An engine as in claim 1, said opening being a jet nozzle.

3. An engine as in claim 1, said lid having a depending stopper for entering each said opening to seal for the power stroke.

4. An engine as in claim 3 said lid being open with arms each supporting a said stopper.

5. An engine as in claim 1, having a crankshaft, a lid rod secured to said lid, at least one connecting rod connecting said crank shaft to said lid rod, said connecting rod having an extended cam arm with cam means connecting said piston to said connecting rod for moving said piston relative to said lid to close said opening for power strokes and opening said opening daring exhaust strokes.

6. A reciprocating piston engine having a cylinder having a jet piston having at least one hole through the piston from head to back, a lid mounted to relatively move up and down on the head end of the piston to open and close said hole, a crankshaft, a piston rod connected between said piston and said crank shaft, a cam on said piston rod for lifting said lid during the return of said piston to the head end of said cylinder to exhaust said cylinder.

7. A reciprocating piston for an engine, said piston having at least one hole through from head to back, a lid for alternately covering and opening said hole.

8. An engine as in claim 1 and an electric arc plug and a water/steam plug through the head end of said cylinder to combine water and heat to make steam in the cylinder for running the engine.

9. a reciprocating piston as in claim 7 and a connecting rod with a cam lever end for controlling the opening and closing of said lid.
